(19) United States
(12) Patent Application Publication
(10) Pub. No.: US 2026/0289202 A1
(43) Pub. Date: Sep. 24, 2026

(54) CONFIGURABLE RADIO-FREQUENCY IDENTIFICATION READER

(71) Applicant: Zebra Technologies Corporation, Lincolnshire, IL (US)

(72) Inventor: David Bellows, Fort Salonga, NY (US)

(21) Appl. No.: 19/682,643

(22) Filed: May 20, 2026

Related U.S. Application Data
(62) Division of application No. 18/633,093, filed on Apr. 11, 2024.

(51) Int. Cl. G06K 7/10

(52) U.S. Cl. CPC G06K 7/10356; G06K 7/10277

(57) ABSTRACT

An example configurable radio-frequency identification (RFID) reader assembly includes a base unit and an integrable multiplexer. The base unit includes a first housing, a printed circuit board (PCB), an internal multiplexer, a first plurality of antenna ports accessible from outside the first housing, and a first radio-frequency (RF) connector accessible from outside the first housing. The integrable multiplexer is attached to the first housing and includes a second housing that is attachable to and removable from the first housing from outside the first housing, a second plurality of antenna ports accessible from outside of the second housing, and a second RF connector accessible from outside the integrable multiplexer housing and connected to the first RF connector.

### CROSS-REFERENCE TO RELATED APPLICATIONS

This application claims priority to, and the benefit of the filing date of, U.S. Non-Provisional application Ser. No. 18/633,093, filed on Apr. 11, 2024 and entitled “Configurable Radio-Frequency Identification Reader,” the entirety of which is hereby incorporated by reference herein.

### BACKGROUND

Currently, there is a need for both four antenna port and eight antenna port radio-frequency identification (RFID) readers to satisfy customer demand. However, current products that offer both four antenna port and eight antenna port options typically use the larger eight antenna port option as the design point, which significantly increases the size of the four antenna port design option beyond what a four antenna port option would actually require. If the size of the four antenna port option is burdened by the eight antenna port option, the resulting four antenna port option would be too large, especially when compared to other four antenna port RFID readers without an eight antenna port counterpart. For example, an RFID reader having eight antenna ports that are aligned horizontally produces an RFID reader that is overly wide when reduced to four antenna ports. In this case, typically four of the eight antenna ports are removed from the RFID reader's enclosure, leaving empty space horizontally and thereby creating an inefficiently sized design. Similarly, a product having eight antenna ports arranged in two vertically aligned or staggered horizontal rows produces an RFID reader that is overly thick when reduced to four antenna ports. Again, four of the eight antenna ports are typically removed from the eight antenna port option to create the four antenna port option without changing the size of the RFID reader's enclosure and thereby creating an inefficiently sized four antenna port design. In many applications, having an overly large four antenna port RFID reader is not acceptable.

Creating separate sets of housings with different sizes for four antenna port and corresponding eight antenna port designs typically is not acceptable as this would be cost-prohibitive for tooling and would require parallel development paths across multiple disciplines, negating the resource and development time advantages of a shared enclosure.

### SUMMARY

In an embodiment, the present invention is a configurable RFID reader assembly comprising a base unit and an integrable multiplexer. The base unit comprises a first housing, a printed circuit board (PCB), an internal multiplexer, a first plurality of antenna ports, and a first radio-frequency (RF) connector. The PCB and the internal multiplexer are positioned within the first housing and the internal multiplexer is communicatively coupled to the PCB. The first plurality of antenna ports is communicatively coupled to the PCB through the internal multiplexer and each of the first plurality of antenna ports extends through a first wall of the first housing and is accessible from outside of the first housing. The RF connector is communicatively coupled to the PCB through the internal multiplexer and is accessible from outside the first housing through a second wall of the first housing, separate from the first wall. The integrable multiplexer is attached to the second wall of the first housing of the base unit and comprises a second housing, a second plurality of antenna ports, and a second RF connector. The second housing is attachable to and removable from the second wall of the first housing. Each of the second plurality of antenna ports extends through the second housing and is accessible from outside of the second housing. The second RF connector is accessible from outside the second housing and is connected to the first RF connector.

In a variation of this embodiment, the first plurality of antenna ports consists of four antenna ports.

In another variation of this embodiment, the second plurality of antenna ports consists of four antenna ports.

In another embodiment, the present invention is a configurable RFID reader assembly comprising a base unit and an RFID reader accessory. The base unit comprises a first housing, a PCB, an internal multiplexer, a first plurality of antenna ports, and a first RF connector. The PCB and the internal multiplexer are positioned in the first housing and the internal multiplexer is communicatively coupled to the PCB. The first plurality of antenna ports is communicatively coupled to the PCB through the internal multiplexer and each of the first plurality of antenna ports extends through a first wall of the first housing and is accessible from outside the first housing. The first RF connector is communicatively coupled to the PCB through the internal multiplexer and is accessible from outside the first housing through a second wall of the first housing, separate from the first wall. The RFID reader accessory is attached to the second wall of the first housing of the base unit, is attachable to and removable from the second wall of the first housing from outside the first housing, and prevents access to the first RF connector with the RFID reader accessory attached to the second wall of the first housing.

In a variation of this embodiment, the first plurality of antenna ports consists of four antenna ports.

In another variation of this embodiment, the RFID reader accessory comprises a cosmetic plate.

In another variation of this embodiment, the RFID reader accessory comprises an integrable RFID antenna attached to the second wall of the first housing of the base unit. The integrable RFID antenna comprises a third housing that is attachable to and removable from the second wall of the first housing from outside the first housing and a third RF connector accessible from outside the third housing and connected to the first RF connector.

In another variation of this embodiment, the RFID reader accessory comprises an integrable multiplexer attached to the second wall of the first housing of the base unit. The integrable multiplexer comprises a second housing that is attachable to and removable from the second wall of the first housing from outside the first housing, a second plurality of antenna ports, each extending through the second housing and accessible from outside the second housing, and a second RF connector accessible from outside the second housing and connected to the first RF connector.

In another variation of this embodiment, the second plurality of antenna ports consists of four antenna ports.

In another variation of this embodiment, the RFID reader accessory comprises an integrable multiplexer/RFID antenna attached to the second wall of the first housing of the base unit. The integrable multiplexer/RFID antenna comprising a fourth housing that is attachable to and removable from the second wall of the first housing from outside the first housing, an internal integrated RFID antenna positioned within the fourth housing, a fourth plurality of antenna ports, each extending through the fourth housing and accessible from outside the fourth housing, and a fourth RF connector accessible from outside the fourth housing and connected to the first RF connector.

In another variation of this embodiment, the fourth plurality of antenna ports consists of three antenna ports.

In another embodiment, the present invention is a method of configuring an RFID reader assembly, comprising: providing a base unit, comprising: a first housing; a printed circuit board (PCB) within the first housing; an internal multiplexer positioned within the first housing and communicatively coupled to the PCB; a first plurality of antenna ports communicatively coupled to the PCB through the internal multiplexer, wherein each of the first plurality of antenna ports extends through a first wall of the first housing and is accessible from outside the first housing; and a first radio-frequency (RF) connector communicatively coupled to the PCB through the internal multiplexer and accessible from outside the first housing through a second wall of the first housing; and attaching a first RFID reader accessory to the second wall of the first housing of the base unit, separate from the first wall. The first RFID reader accessory is an integrable multiplexer comprising a second housing that is attachable to and removable from the second wall of the first housing from outside the first housing, a second plurality of antenna ports, wherein each of the second plurality of antenna ports extends through the second housing and is accessible from outside of the second housing, and a second RF connector accessible from outside the second housing and connected to the first RF connector.

In a variation of this embodiment, the first plurality of antenna ports consists of four antenna ports.

In another variation of this embodiment, the second plurality of antenna ports consists of four antenna ports.

In another variation of this embodiment, the method comprises removing the first RFID reader accessory from the second wall of the first housing and attaching a second RFID reader accessory to the second wall of the first housing.

In another variation of this embodiment, the second RFID accessory is an integrable RFID antenna comprising a third housing that is attachable to and removable from the second wall of the first housing from outside the first housing and a third RF connector accessible from outside the third housing. The method comprises connecting the third RF connector to the first RF connector and attaching the third housing to the second wall of the first housing.

In another variation of this embodiment, the second RFID reader accessory is a cosmetic plate that prevents access to the first RF connector with the cosmetic plate attached to the second wall of the first housing.

In another variation of this embodiment, the second RFID accessory is an integrable multiplexer/RFID antenna comprising a fourth housing that is attachable to and removable from the second wall of the first housing from outside the first housing, an internal integrated RFID antenna, a fourth plurality of antenna ports communicatively coupled to the PCB through the internal multiplexer, extending through the fourth housing, and accessible from outside the fourth housing; and a fourth RF connector accessible from outside the fourth housing. The method comprises connecting the fourth RF connector to the first RF connector and attaching the fourth housing to the second wall of the first housing.

In another variation of this embodiment, the fourth plurality of antenna ports consists of three antenna ports.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a perspective view of a first example configurable RFID reader assembly with an integrable multiplexer;

FIG. 2 illustrates a perspective view of the configurable RFID reader assembly of FIG. 1 with the integrable multiplexer removed from the base unit;

FIG. 3 illustrates a side view of the configurable RFID reader assembly of FIG. 1;

FIG. 4 illustrates a perspective view of a second example configurable RFID reader assembly with an integrable RFID antenna;

FIG. 5 illustrates a perspective view of the configurable RFID reader assembly of FIG. 4 with the integrable RFID antenna removed from the base unit;

FIG. 6 illustrates a perspective view of a third example configurable RFID reader assembly with a cosmetic plate;

FIG. 7 illustrates a perspective view of the configurable RFID reader assembly of FIG. 6 with the cosmetic plate removed from the base unit;

FIG. 8 illustrates a perspective view of a fourth example configurable RFID reader assembly with an integrable multiplexer/RFID antenna;

FIG. 9 illustrates a perspective view of the configurable RFID reader assembly of FIG. 8 with the integrable multiplexer/RFID antenna removed from the base unit; and

FIG. 10 is a flowchart illustrating an example method of configuring an RFID reader assembly.

Skilled artisans will appreciate that elements in the figures are illustrated for simplicity and clarity, have not necessarily been drawn to scale, and that details that are not necessary for an understanding of the invention or that render other details difficult to perceive may be omitted. For example, the dimensions of some of the elements in the figures may be exaggerated relative to other elements to help to improve understanding of embodiments of the present invention.

The apparatus components have been represented where appropriate by conventional symbols in the drawings, showing only those components and specific details that are pertinent to understanding the examples of the present invention so as not to obscure the disclosure with details that will be readily apparent to those of ordinary skill in the art having the benefit of the description herein.

### DETAILED DESCRIPTION

The example configurable RFID reader assemblies and methods disclosed herein can be used to expand the number of antenna ports in an RFID reader assembly without substantially increasing the overall size. To accomplish this, the base unit of the RFID reader assembly has an expansion interface that is used to physically attach and/or electrically connect an RFID reader accessory (e.g., an integrable multiplexer, an integrable RFID antenna, a cosmetic plate, etc.) to the base unit. With an integrable multiplexer, the RFID reader assembly can be reconfigured, for example, from four ports (base unit) to eight ports (base unit and integrable multiplexer). The RFID reader assembly retains the same smaller footprint regardless of the configuration and number of antenna ports, with only the thickness of the RFID reader assembly being increased slightly when reconfigured from four ports to eight ports.

For example, a base version of the RFID reader assembly could have four antenna ports and a cosmetic plate attached to the expansion interface. If an additional antenna is desired (e.g., four external antenna ports and one integrated antenna), the cosmetic plate can be removed and an integrable RFID antenna can be connected to an RF connector that passes through a sealed opening in the base unit and attached to the expansion interface of the base unit. If it is desired for the RFID reader to drive even more antennas, the cosmetic plate or integrable RFID antenna could be removed from the base unit and an integrable multiplexer can be connected to the RF connector and attached to the expansion interface of the base unit. Therefore, instead of occupying an external antenna port in the base unit to connect an external multiplexer, which itself would take up additional space in the system installation, to obtain additional antenna ports, the integration of the integrable multiplexer provides added antenna ports directly in the RFID reader itself without occupying any of the external antenna ports in the base unit and without increasing the footprint of the RFID reader assembly.

Using a smaller base unit and various RFID reader accessories can address various installation constraints, such as installation of RFID readers in confined areas (e.g., under counters, in equipment closets, inside ceiling structures, etc.), which require smaller products. In addition, the aesthetics/perception of an RFID reader having a smaller base unit with integrable RFID reader accessories is addressed, as customers typically do not want overly large units for no reason (e.g., the size of an eight port unit, but with only four ports). Also, the smaller base unit with various RFID reader accessories provides a consistent appearance for all members of a product family, which can be important for maintaining a company's brand and product portfolio. Furthermore, in addition to the benefits of reducing the product's size and cost and providing product configuration flexibility, the system installation is simplified by eliminating the need for a separate external multiplexer (and the additional cable, along with its inherent loss, required to connect the RFID reader to the multiplexer) to get more than the four antenna ports the typical RFID reader is equipped with. For example, many installations use four antenna port RFID readers, even though they need up to eight antenna ports in their application, because four antenna port RFID readers are more readily available. Eight antenna port RFID readers are less common because, as discussed above, it is not efficient to develop two different enclosures for an RFID reader-one for a four antenna port configuration and another for an eight antenna port configuration. So, rather than share a common enclosure and let the eight antenna port configuration unnecessarily increase the size of the four antenna port configuration, many companies choose to not make an eight antenna port product and instead focus just on four antenna port RFID readers. However, using external multiplexers can make installations cumbersome as well as unnecessarily more complicated and expensive. Moreover, when using a four-to-one separate external multiplexer, for example, the cable that makes the connection between the four antenna port RFID reader and the multiplexer occupies one of the four antenna ports of the RFID reader. This leaves three antenna ports remaining plus the four antenna ports on the separate external multiplexer for a total of seven ports instead of the desired eight.

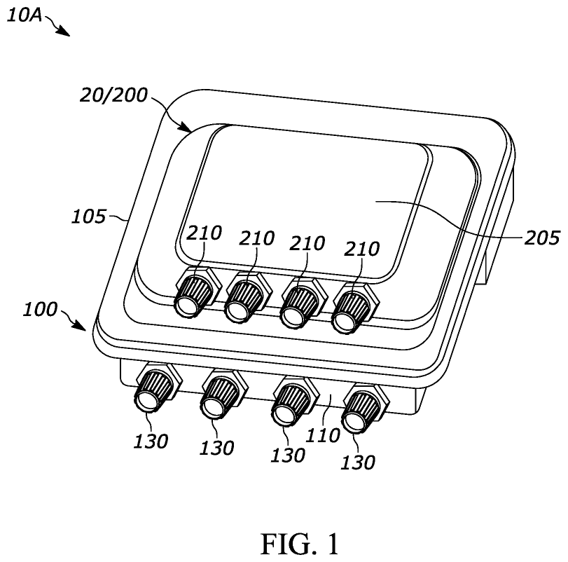

Referring to FIGS. 1-3, a first example configurable RFID reader assembly 10A is illustrated that generally includes a base unit 100 and an RFID reader accessory 20, which in the example shown is an integrable multiplexer 200.

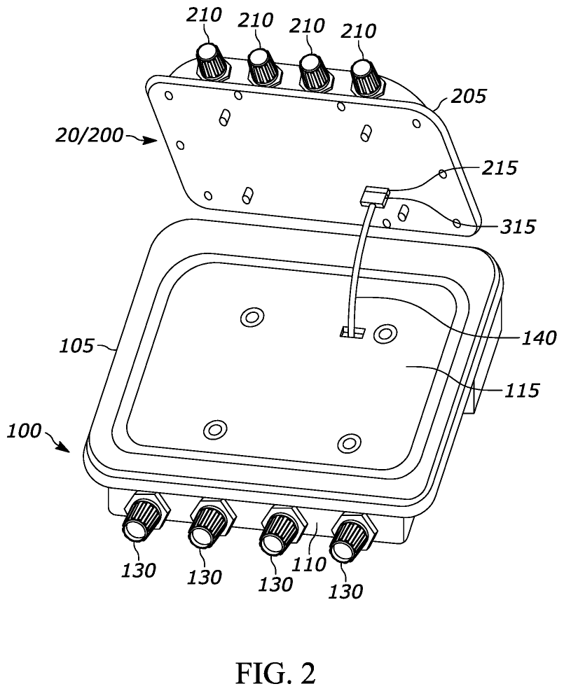

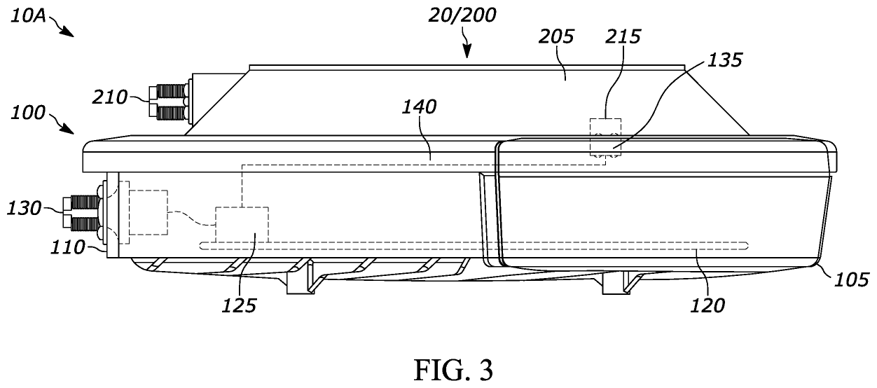

Base unit 100 has a first housing 105 and a printed circuit board (PCB) 120 positioned within first housing 105. An internal multiplexer 125 is positioned within first housing 105 and is communicatively coupled to PCB 120. Internal multiplexer 125 could be mounted to PCB 120 or can be communicatively coupled to PCB 120 through a wired connection or any other well known method. A first plurality of antenna ports 130 is communicatively coupled to PCB 120 through internal multiplexer 125. Each of first plurality of antenna ports 130 may be assembled directly to PCB 120, and a PCB trace may run between each antenna port and internal multiplexer 125. Alternatively, each of first plurality of antenna ports 130 may be connected to PCB 120 via a flexible printed circuit or wire harness. In another embodiment, a combination of these assembly and connection methods may be used where some or all of first plurality of antenna ports 130 may be ganged together on a separate PCB, and a flexible printed circuit or wire harness may connect this separate PCB to PCB 120. First plurality of antenna ports 130 could consist of, but are not limited to, RP-TNC connectors, TNC connectors, RP-BNC connectors, BNC connectors, RP-SMA connectors, SMA connectors, RP-Type N connectors, Type N connectors, FAKRA connectors, etc., or any combination thereof. First plurality of antenna ports 130 are essentially RF connectors that accept RF cable assemblies, which could typically consist of coaxial cables and the corresponding mating RF connectors, and are used to connect the RFID reader to RFID antennas. Each of first plurality of antenna ports 130 extends through a first wall 110 of first housing 105 so that each is accessible from outside of first housing 105. As shown in the Figures, first plurality of antenna ports 130 preferably consists of four antenna ports, but any number of antenna ports could be used depending on the particular application. A first radio-frequency (RF) connector 135 is also communicatively coupled to PCB 120 through internal multiplexer 125. First RF connector 135 is designed to work at frequencies in at least the RFID band. First RF connector 135 may be an MMCX connector, MCX connector, MMBX connector, SMB connector, SMA connector, RP-SMA connector, or the like. Alternatively, first RF connector may include a spring-loaded contact(s), such as a pogo pin(s), or printed conductive pad(s) on a PCB or flexible printed circuit that interface with a spring-loaded contact(s), such as a pogo pin(s). First RF connector 135 is accessible from outside first housing 105 through a second wall 115 of first housing 105, which is separate from first wall 110. Having first RF connector 135 accessible from outside first housing 105 makes it easier to manufacture RFID reader assembly 10A, as RFID reader accessory 20/integrable multiplexer 200 can be connected and attached to base unit 100 after base unit 100 is fully assembled. This also allows the RFID reader assembly to be easily reconfigured with another RFID reader accessory during manufacturing, in the field, or for service, as discussed below. As shown in FIGS. 2 and 3, first RF connector 135 is communicatively coupled to PCB 120 and internal multiplexer 125 via a wired connection, with the wire 140 extending through an aperture in second wall 115. The wired connection may utilize coaxial cable. The end of wire 140 that is opposite the end of first RF connector 135 may be directly connected, by soldering for example, to PCB 120, and a PCB trace may run between this connection and internal multiplexer 125. Alternatively, wire 140 may include another RF connector at the end opposite of first RF connector 135, which can connect to a mating RF connector on PCB 120. First RF connector 135 could alternatively be mounted to second wall 115 and wire 140 could be positioned within first housing 105. In another embodiment, first RF connector 135 could be electrically and physically connected directly to PCB 120 by soldering, for example. In another embodiment, first RF connector 135 could be mounted on a flexible printed circuit that connects to PCB 120. It yet another embodiment, first RF connector 135 could be communicatively coupled to a secondary PCB, which is coupled to PCB 120 via another connector or connector pair, cable, wire harness, flexible printed circuit, spring contacts, or the like.

Base unit 100 can be configured to include a controller, a memory, and an RF transceiver/transmitter. The controller of base unit 100 may be configured to interact with the memory to obtain, for example, machine-readable instructions stored in the memory. When at least one port of first plurality of antenna ports 130 has an RFID antenna connected to it, base unit 100 can energize the antenna(s) to radiate RF energy over an antenna beam pattern(s) and to receive RF response signals from RFID tags in the vicinity of base unit 100, thereby interrogating and processing the payloads of the RFID tags that are in read range of base unit 100. During operation, base unit 100 may capture RFID tag information (e.g., an Electronic Product Code (EPC)) that identifies specific RFID tags. Base unit 100 may transmit electronic information, including any RFID tag data, to an external server and/or controller for processing, and/or it may process the data within base unit 100. For example, the external server and/or controller may include a network communication interface communicatively coupled to network communication interfaces of base unit 100 to receive RFID information. This may be a wired Power over Ethernet (PoE) connection or a wireless connection, such as Bluetooth, wireless local area network (WLAN), wireless wide area network (WWAN), or the like. Base unit 100 may also receive information, commands, or execution instructions from the external server and/or controller. In some embodiments, base unit 100 may be a device that executes and/or conforms to any suitable software operating system (e.g., Android, iOS), a custom Internet of Things (IoT) bridge device with a BLE radio, an RFID transceiver/transmitter, and/or any other suitable device or combination thereof. Base unit 100 may be configured to periodically interrogate nearby RFID tags, transmit the tag data obtained therein to the external server and/or controller, and/or broadcast requests received from the external server and/or controller to such nearby tags.

RFID reader accessory 20/integrable multiplexer 200 is attached to second wall 115 of first housing 105 of base unit 100 and is attachable to and removable from second wall 115 from outside of first housing 105. Attachment means can include, but are not limited to, fasteners such as screws, snaps, hooks, latches, friction fits, adhesive, magnets, clips, hook and loop material, and locking mechanisms. Having RFID reader accessory 20/integrable multiplexer 200 attachable to and removable from second wall 115 of base unit 100 from outside of first housing 105 makes it easier to manufacture RFID reader assembly 10A, as RFID reader accessory 20/integrable multiplexer 200 can be attached to base unit 100 after base unit 100 is fully assembled. This also allows the RFID reader assembly to be easily reconfigured with other RFID reader accessories during manufacturing, in the field, or for service, as discussed below. RFID reader accessory 20/integrable multiplexer 200 also prevents access to first RF connector 135 with RFID reader accessory 20/integrable multiplexer 200 attached to second wall 115.

In the example shown, integrable multiplexer 200 generally includes a second housing 205, a second plurality of antenna ports 210, and a second RF connector 215. Second housing 205 is attachable to and removable from second wall 115 of first housing 105 from outside of first housing 105, as discussed above. Second plurality of antenna ports 210 could consist of, but are not limited to, RP-TNC connectors, TNC connectors, RP-BNC connectors, BNC connectors, RP-SMA connectors, SMA connectors, RP-Type N connectors, Type N connectors, FAKRA connectors, etc., or any combination thereof, and each of second plurality of antenna ports 210 extends through second housing 205 so that each is accessible from outside of second housing 205. As shown in the Figures, second plurality of antenna ports 210 preferably consists of four antenna ports, but any number of antenna ports could be used depending on the particular application. Second RF connector 215 is also accessible from outside second housing 205 and is connected to first RF connector 135 of base unit 100. Second RF connector 215 is designed to work at frequencies in at least the RFID band. Second RF connector 215 may be an MMCX connector, MCX connector, MMBX connector, SMB connector, SMA connector, RP-SMA connector, or the like. Alternatively, second RF connector 215 may include printed conductive pad(s) on a PCB or flexible printed circuit if first RF connector 135 includes a spring-loaded contact(s), such as a pogo pin(s). Similarly, second RF connector 215 may include a spring-loaded contact(s), such as a pogo pin(s), if first RF connector 135 includes printed conductive pad(s) on a PCB or flexible printed circuit. In these arrangements, first RF connector 135 and second RF connector 215 may form a one-piece interface. Having second RF connector 215 accessible from outside second housing 205 makes it easier to manufacture RFID reader assembly 10A, as RFID reader accessory 20/integrable multiplexer 200 can be connected and attached to base unit 100 after RFID reader accessory 20/integrable multiplexer 200 is fully assembled. This also allows the RFID reader assembly to be easily reconfigured with other RFID reader accessories during manufacturing, in the field, or for service, as discussed below. Second RF connector 215 is communicatively coupled to second plurality of antenna ports 210 inside second housing 205. With second RF connector 215 connected to first RF connector 135, second plurality of antenna ports 210 is coupled to PCB 120 of base unit 100 through internal multiplexer 125. A general-purpose input/output (GPIO) signal that controls which antenna port of the second plurality of antenna ports 210 is active could be passed from PCB 120 to integrable multiplexer 200 through first RF connector 135 and second RF connector 215.

By using base unit 100 and integral multiplexer 200, the size of base unit 100 (having four antenna ports) can be kept small and the addition of integrable multiplexer 200 can expand configurable RFID reader assembly 10A to eight antenna ports without significantly increasing the size of configurable RFID reader assembly 10A.

In an alternate embodiment, internal multiplexer 125 can be replaced with a single pole double throw switch, where the common line is connected to an RFID radio communicatively coupled to PCB 120, one switch leg is connected to the common line of a single pole “x” throw switch (where x =the number of antenna ports in the first plurality of antenna ports 130, such as four) on PCB 120, and the other switch leg is connected to first RF connector 135. Each leg of the single pole “x” throw switch is connected to a different antenna port of first plurality of antenna ports 130. In integrable multiplexer 200, electrically in between second RF connector 215 and second plurality of antenna ports 210 is a single pole “y” throw switch (where y =the number of antenna ports in the second plurality of antenna ports 210, such as four). Each leg of the single pole “y” throw switch is connected to a different antenna port of second plurality of antenna ports 210, and the common line of the single pole “y” throw switch is connected to the second RF connector 215. In the example where x =4 and y =4, the configurable RFID reader assembly would have a total of eight antenna ports. An alternative could be to replace the single pole double throw switch with a 2:1 multiplexer, replace the single pole “x” throw switch with a x: 1 multiplexer, and replace the single pole “y” throw switch with a y: 1 multiplexer.

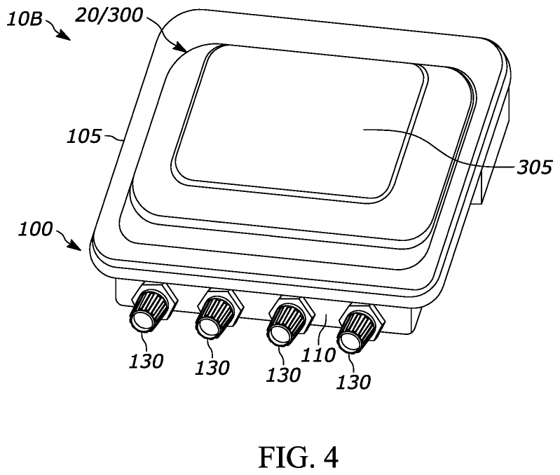

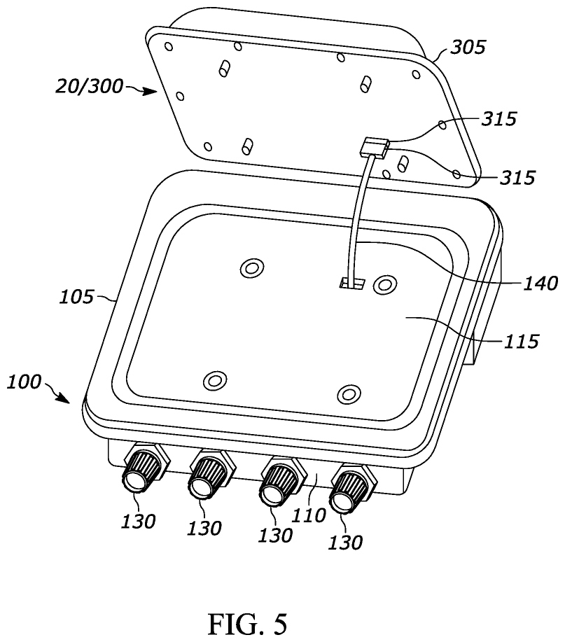

Referring to FIGS. 4-5, a second example configurable RFID reader assembly 10B is illustrated that generally includes base unit 100 and RFID reader accessory 20, which in the example shown is an integrable RFID antenna 300.

RFID reader accessory 20/integrable RFID antenna 300 is attached to second wall 115 of first housing 105 of base unit 100 and is attachable to and removable from second wall 115 from outside of first housing 105. Attachment means can include, but are not limited to, fasteners such as screws, snaps, hooks, latches, friction fits, adhesive, magnets, clips, hook and loop material, and locking mechanisms. Having RFID reader accessory 20/integrable RFID antenna 300 attachable to and removable from second wall 115 of base unit 100 from outside of first housing 105 makes it easier to manufacture configurable RFID reader assembly 10B, as RFID reader accessory 20/integrable RFID antenna 300 can be attached to base unit 100 after base unit 100 is fully assembled. This also allows the RFID reader assembly to be easily reconfigured with other RFID reader accessories during manufacturing, in the field, or for service, as discussed below. RFID reader accessory 20/integrable RFID antenna 300 prevents access to first RF connector 135 with RFID reader accessory 20/integrable RFID antenna 300 attached to second wall 115.

In the example shown, integrable RFID antenna 300 generally includes a third housing 305 and a third RF connector 315. Third housing 305 is attachable to and removable from second wall 115 of first housing 105 of base unit 100 from outside of first housing 105, as discussed above. Third RF connector 315 is accessible from outside third housing 305 of integrable RFID antenna 300 and is connected to first RF connector 135. Third RF connector 315 is connected to first RF connector 135 to communicatively couple integrable RFID antenna 300 to PCB 120 of base unit 100 through internal multiplexer 125. Third RF connector 315 is designed to work at frequencies in at least the RFID band. Third RF connector 315 may be an MMCX connector, MCX connector, MMBX connector, SMB connector, SMA connector, RP-SMA connector, or the like. Alternatively, third RF connector 315 may include printed conductive pad(s) on a PCB or flexible printed circuit if first RF connector 135 includes a spring-loaded contact(s), such as a pogo pin(s). Similarly, third RF connector 315 may include a spring-loaded contact(s), such as a pogo pin(s), if first RF connector 135 includes printed conductive pad(s) on a PCB or flexible printed circuit. In these arrangements, first RF connector 135 and third RF connector 315 may form a one-piece interface. Having third RF connector 315 accessible from outside third housing 305 makes it easier to manufacture configurable RFID reader assembly 10B, as RFID reader accessory 20/integrable RFID antenna 300 can be connected and attached to base unit 100 after RFID reader accessory 20/integrable RFID antenna 300 is fully assembled. This also allows the RFID reader assembly to be easily reconfigured with other RFID reader accessories during manufacturing, in the field, or for service as discussed below.

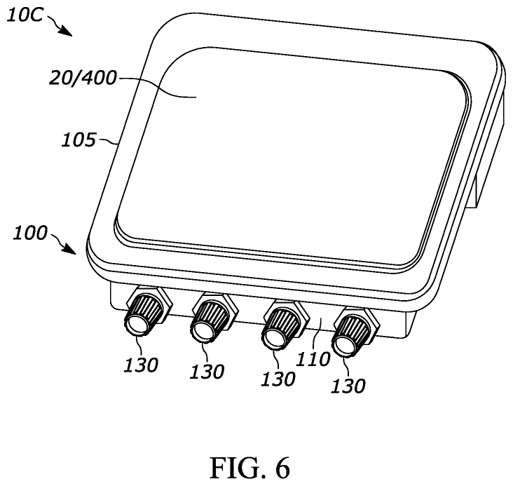

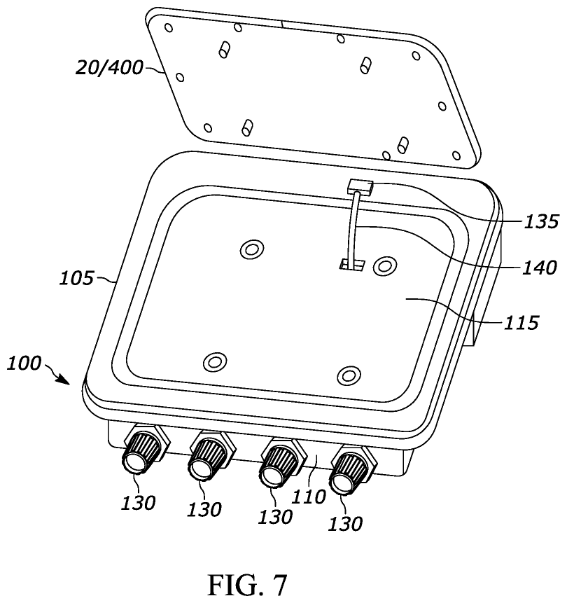

Referring to FIGS. 6-7, a third example configurable RFID reader assembly 10C is illustrated that generally includes base unit 100 and RFID reader accessory 20, which in the example shown is a cosmetic plate 400.

RFID reader accessory 20/cosmetic plate 400 is attached to second wall 115 of first housing 105 of base unit 100 and is attachable to and removable from second wall 115 from outside of first housing 105. Attachment means can include, but are not limited to, fasteners such as screws, snaps, hooks, latches, friction fits, adhesive, magnets, clips, hook and loop material, and locking mechanisms. Having RFID reader accessory 20/cosmetic plate 400 attachable to and removable from second wall 115 of base unit 100 from outside of first housing 105 makes it easier to manufacture configurable RFID reader assembly 10C, as RFID reader accessory 20/cosmetic plate 400 can be attached to base unit 100 after base unit 100 is fully assembled. This also allows the RFID reader assembly to be easily reconfigured with other RFID reader accessories during manufacturing, in the field, or for service, as discussed below. RFID reader accessory 20/cosmetic plate 400 prevents access to first RF connector 135 with RFID reader accessory 20/cosmetic plate 400 attached to second wall 115.

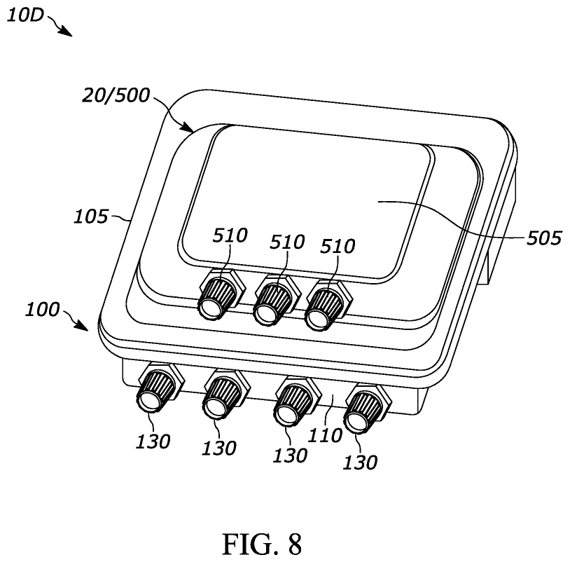

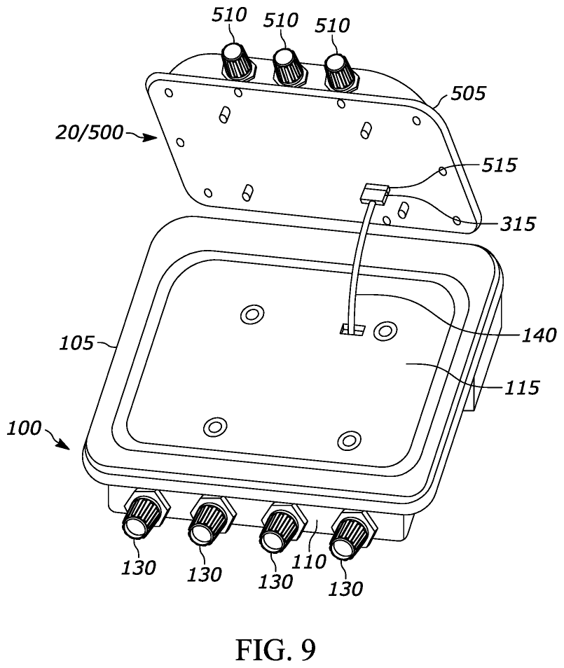

Referring to FIGS. 8-9, a fourth example configurable RFID reader assembly 10D is illustrated that generally includes base unit 100 and RFID reader accessory 20, which in the example shown is an integrable multiplexer/RFID antenna 500.

RFID reader accessory 20/integrable multiplexer/RFID antenna 500 is attached to second wall 115 of first housing 105 of base unit 100 and is attachable to and removable from second wall 115 from outside of first housing 105. Attachment means can include, but are not limited to, fasteners such as screws, snaps, hooks, latches, friction fits, adhesive, magnets, clips, hook and loop material, and locking mechanisms. Having RFID reader accessory 20/integrable multiplexer/RFID antenna 500 attachable to and removable from second wall 115 of base unit 100 from outside of first housing 105 makes it easier to manufacture configurable RFID reader assembly 10D, as RFID reader accessory 20/integrable multiplexer/RFID antenna 500 can be attached to base unit 100 after base unit 100 is fully assembled. This also allows the RFID reader assembly to be easily reconfigured with other RFID reader accessories during manufacturing, in the field, or for service, as discussed below. RFID reader accessory 20/integrable multiplexer/RFID antenna 500 also prevents access to first RF connector 135 with RFID reader accessory 20/integrable multiplexer/RFID antenna 500 attached to second wall 115.

In the example shown, integrable multiplexer/RFID antenna 500 generally includes a fourth housing 505, a fourth plurality of antenna ports 510, a fourth RF connector 515, and an internal integral RFID antenna. Fourth housing 505 is attachable to and removable from second wall 115 of first housing 105 from outside of first housing 105, as discussed above. Fourth plurality of antenna ports 510 could consist of, but are not limited to, RP-TNC connectors, TNC connectors, RP-BNC connectors, BNC connectors, RP-SMA connectors, SMA connectors, RP-Type N connectors, Type N connectors, FAKRA connectors, etc., or any combination thereof, and each of fourth plurality of antenna ports 510 extends through fourth housing 505 so that each is accessible from outside of fourth housing 505. As shown in the Figures, fourth plurality of antenna ports 510 preferably consists of three antenna ports, but any number of antenna ports could be used depending on the particular application. The inclusion of three antenna ports and the internal integral RFID antenna provides a possible eight antennas (seven external ports and one internal integral RFID antenna) between integrable multiplexer/RFID antenna 500 and base unit 100. Fourth RF connector 515 is also accessible from outside fourth housing 505 and is connected to first RF connector 135 of base unit 100. Fourth RF connector 515 is designed to work at frequencies in at least the RFID band. Fourth RF connector 515 may be an MMCX connector, MCX connector, MMBX connector, SMB connector, SMA connector, RP-SMA connector, or the like. Alternatively, fourth RF connector 515 may include printed conductive pad(s) on a PCB or flexible printed circuit if first RF connector 135 includes a spring-loaded contact(s), such as a pogo pin(s). Similarly, fourth RF connector 515 may include a spring-loaded contact(s), such as a pogo pin(s), if first RF connector 135 includes printed conductive pad(s) on a PCB or flexible printed circuit. In these arrangements, first RF connector 135 and fourth RF connector 515 may form a one-piece interface. Having fourth RF connector 515 accessible from outside fourth housing 505 makes it easier to manufacture configurable RFID reader assembly 10D, as RFID reader accessory 20/integrable multiplexer/RFID antenna 500 can be connected and attached to base unit 100 after RFID reader accessory 20/integrable multiplexer/RFID antenna 500 is fully assembled. This also allows the RFID reader assembly to be easily reconfigured with other RFID reader accessories during manufacturing, in the field, or for service, as discussed below. Fourth RF connector 515 is communicatively coupled to fourth plurality of antenna ports 510 inside fourth housing 505 and the internal integral RFID antenna of integrable multiplexer/RFID antenna 500 inside fourth housing 505. With fourth RF connector 515 connected to first RF connector 135, fourth plurality of antenna ports 510 and the internal integral RFID antenna of integrable multiplexer/RFID antenna 500 are coupled to PCB 120 of base unit 100 through internal multiplexer 125. A general-purpose input/output (GPIO) signal that controls which antenna port of fourth plurality of antenna ports 510 and the internal integral RFID antenna of integrable multiplexer/RFID antenna 500 is active could be passed from PCB 120 to integrable multiplexer/RFID antenna 500 through first RF connector 135 and fourth RF connector 515.

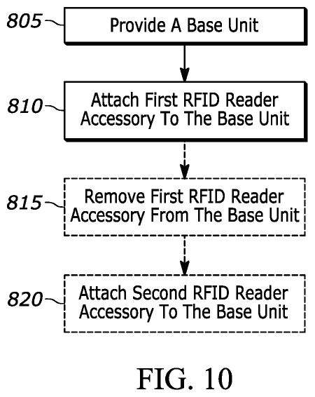

Referring to FIG. 10, an example method of configuring an RFID reader assembly (e.g., configurable RFID reader assemblies 10A, 10B, 10C, 19D) is illustrated. At Step 805, a base unit (e.g., base unit 100) is provided. The base unit preferably includes a first housing (e.g., first housing 105), a printed circuit board (e.g., PCB 120) within the first housing, an internal multiplexer (e.g., internal multiplexer 125) within the first housing and communicatively coupled to the PCB, a first plurality of antenna ports (e.g., first plurality of antenna ports 130) that are communicatively coupled to the PCB through the internal multiplexer and extend through a first wall (e.g., first wall 110) of the first housing and are accessible from outside the first housing, and a first RF connector (e.g., first RF connector 135) communicatively coupled to the PCB through the internal multiplexer and accessible from outside the first housing through a second wall (e.g., second wall 115) of the first housing.

At Step 810, a first RFID reader accessory (e.g., integrable multiplexer 200) is attached to the second wall of the first housing of the base unit. Preferably, the first RFID reader accessory includes a second housing (e.g., second housing 205) that is attachable to and removable from the second wall of the first housing from outside of the first housing, a second plurality of antenna ports (e.g., second plurality of antenna ports 210) that each extend through the second housing and are accessible from outside the second housing, and a second RF connector (e.g., second RF connector 215) that is also accessible from outside the second housing and is connected to the first RF connector.

In some examples, to reconfigure the RFID reader assembly, at Step 815, the first RFID reader accessory is removed from the base unit. In the example where the first RFID reader accessory is integrable multiplexer 200, second housing 205 of integrable multiplexer 200 would be removed from second wall 115 of first housing 105 of base unit 100 and second RF connector 215 of integrable multiplexer 200 would be disconnected from first RF connector 135 of base unit 100.

At Step 820, a second RFID reader accessory (e.g., integrable RFID antenna 300, cosmetic plate 400, or integrable multiplexer/RFID antenna 500) can be attached to the base unit. In the example where the second RFID reader accessory is integrable RFID antenna 300, third RF connector 315 of integrable RFID antenna 300 is connected to first RF connector 135 of base unit 100 and third housing 305 of integrable RFID antenna 300 is attached to second wall 115 of first housing 105 of base unit 100. In the example where the second RFID reader accessory is cosmetic plate 400, cosmetic plate 400 is attached to second wall 115 of first housing 105 of base unit 100 such that cosmetic plate 400 covers and prevents access to first RF connector 135. In the example where the second RFID reader accessory is integrable multiplexer/RFID antenna 500, fourth RF connector 515 of integrable multiplexer/RFID antenna 500 is connected to first RF connector 135 of base unit 100 and fourth housing 505 of integrable multiplexer/RFID antenna 500 is attached to second wall 115 of first housing 105 of base unit 100.

The RFID reader assembly can be reconfigured from any configuration to any other configuration as desired. For example, if the RFID reader assembly is configured with an integrable multiplexer, the integrable multiplexer can be replaced with an integrable RFID antenna, a cosmetic plate, or an integrable multiplexer/RFID antenna. Alternatively, the integrable multiplexer can be replaced with another integrable multiplexer that has a different number of antenna ports and/or that uses a different connector type for some or all of the antenna ports. If the RFID reader assembly is configured with an integrable RFID antenna, the integrable RFID antenna can be replaced with an integrable multiplexer, a cosmetic plate or an integrable multiplexer/RFID antenna. Alternatively, the integrable RFID antenna can be replaced with another integrable RFID antenna that has different parameters, such as physical size and/or appearance, and/or performance characteristics, such as gain, radiation pattern, beamwidth, efficiency, VSWR, bandwidth, polarization, and/or impedance. If the RFID reader assembly is configured with a cosmetic plate, the cosmetic plate could be replaced with an integrable multiplexer, an integrable RFID antenna, or an integrable multiplexer/RFID antenna. Alternatively, the cosmetic plate can be replaced with another cosmetic plate that has a different appearance, such as a different color, shape, and/or logo, etc. If the RFID reader assembly is configured with an integrable multiplexer/RFID antenna, the integrable multiplexer/RFID antenna can be replaced with an integrable multiplexer, an RFID antenna, or a cosmetic plate. Alternatively, the integrable multiplexer/RFID antenna can be replaced with another integrable multiplexer/RFID antenna that has a different number of antenna ports and/or that uses a different connector type for some or all of the antenna ports and/or that has different parameters, such as physical size and/or appearance, and/or that has different performance characteristics, such as gain, radiation pattern, beamwidth, efficiency, VSWR, bandwidth, polarization, and/or impedance. The configurability of the RFID reader assembly allows for easy reconfiguration in the field. In addition, it can also simplify its manufacture. For example, the base units can be manufactured in the same manner, regardless of the configuration they will be used in, as the base unit is the same in all configurations. Then depending on the orders, an integrable multiplexer, integrable RFID antenna, cosmetic plate, or integrable multiplexer/RFID antenna could be easily added to existing base units as described above. In some instances, especially for service, it may be desired to replace an RFID reader accessory with another accessory of the same type (e.g., remove an integrable multiplexer and replace it with another integrable multiplexer, such as an identical integrable multiplexer). The ease of configurability of the RFID reader assembly makes it easier to troubleshoot issues as well as make repairs.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

The claims are:

1. A configurable radio-frequency identification (RFID) reader assembly, comprising:
a base unit, comprising:
a first housing;
a printed circuit board (PCB) positioned within the first housing;
an internal multiplexer positioned within the first housing and communicatively coupled to the PCB;
a first plurality of antenna ports communicatively coupled to the PCB through the internal multiplexer, wherein each of the first plurality of antenna ports extends through a first wall of the first housing and is accessible from outside the first housing;
a first radio-frequency (RF) connector communicatively coupled to the PCB through the internal multiplexer, wherein the first RF connector is accessible from outside the first housing through a second wall of the first housing, separate from the first wall; and
an RFID reader accessory attached to the second wall of the first housing of the base unit, wherein the RFID reader accessory is attachable to and removable from the second wall of the first housing from outside the first housing and prevents access to the first RF connector with the RFID reader accessory attached to the second wall of the first housing.

2. The configurable RFID reader assembly of claim 1, wherein the RFID reader accessory comprises a cosmetic plate.

3. The configurable RFID reader assembly of claim 1, wherein the RFID reader accessory comprises an integrable RFID antenna attached to the second wall of the first housing of the base unit, the integrable RFID antenna comprising:
a third housing that is attachable to and removable from the second wall of the first housing from outside the first housing; and
a third RF connector accessible from outside the third housing and connected to the first RF connector.

4. The configurable RFID reader assembly of claim 1, wherein the RFID reader accessory comprises an integrable multiplexer attached to the second wall of the first housing of the base unit, the integrable multiplexer comprising:
a second housing that is attachable to and removable from the second wall of the first housing from outside the first housing;
a second plurality of antenna ports, wherein each of the second plurality of antenna ports extends through the second housing and is accessible from outside the second housing; and
a second RF connector accessible from outside the second housing and connected to the first RF connector.

5. The configurable RFID reader assembly of claim 4, wherein the second plurality of antenna ports consists of four antenna ports.

6. The configurable RFID reader assembly of claim 1, wherein the RFID reader accessory comprises an integrable multiplexer/RFID antenna attached to the second wall of the first housing of the base unit, the integrable multiplexer/RFID antenna comprising:
a fourth housing that is attachable to and removable from the second wall of the first housing from outside the first housing;
an internal integrated RFID antenna positioned within the fourth housing;
a fourth plurality of antenna ports, wherein each of the fourth plurality of antenna ports extends through the fourth housing and is accessible from outside the fourth housing; and
a fourth RF connector accessible from outside the fourth housing and connected to the first RF connector.

7. The configurable RFID reader assembly of claim 6, wherein the fourth plurality of antenna ports consists of three antenna ports.

8. A method of configuring a radio-frequency identification (RFID) reader assembly, comprising:
providing a base unit, comprising: a first housing; a printed circuit board (PCB) within the first housing; an internal multiplexer positioned within the first housing and communicatively coupled to the PCB; a first plurality of antenna ports communicatively coupled to the PCB through the internal multiplexer, wherein each of the first plurality of antenna ports extends through a first wall of the first housing and is accessible from outside the first housing; and a first radio-frequency (RF) connector communicatively coupled to the PCB through the internal multiplexer and accessible from outside the first housing through a second wall of the first housing; and
attaching a first RFID reader accessory to the second wall of the first housing of the base unit, separate from the first wall; wherein
the first RFID reader accessory is an integrable multiplexer, the integrable multiplexer comprising:
a second housing that is attachable to and removable from the second wall of the first housing from outside the first housing;
a second plurality of antenna ports, wherein each of the second plurality of antenna ports extends through the second housing and is accessible from outside of the second housing; and
a second RF connector accessible from outside the second housing and connected to the first RF connector.

9. The method of claim 8, comprising: removing the first RFID reader accessory from the second wall of the first housing and attaching a second RFID reader accessory to the second wall of the first housing.

10. The method of claim 9, wherein:
the second RFID accessory is an integrable RFID antenna, comprising: a third housing that is attachable to and removable from the second wall of the first housing from outside the first housing; and a third RF connector accessible from outside the third housing; and
the method comprises connecting the third RF connector to the first RF connector and attaching the third housing to the second wall of the first housing.

11. The method of claim 9, wherein the second RFID reader accessory is a cosmetic plate, the cosmetic plate preventing access to the first RF connector with the cosmetic plate attached to the second wall of the first housing.

12. The method of claim 9, wherein:
the second RFID accessory is an integrable multiplexer/RFID antenna, comprising: a fourth housing that is attachable to and removable from the second wall of the first housing from outside the first housing; an internal integrated RFID antenna; a fourth plurality of antenna ports communicatively coupled to the PCB through the internal multiplexer, wherein each of the fourth plurality of antenna ports extends through the fourth housing and is accessible from outside the fourth housing; and a fourth RF connector accessible from outside the fourth housing; and
the method comprises connecting the fourth RF connector to the first RF connector and attaching the fourth housing to the second wall of the first housing.

13. The method of claim 12, wherein the fourth plurality of antenna ports consists of three antenna ports.
